(19) United States
(12) Patent Application Publication
(10) Pub. No.: US 2015/0131030 A1
(43) Pub. Date: May 14, 2015

(54) DISPLAY DEVICE

(71) Applicant: Panasonic Intellectual Property Management Co., Ltd., Osaka (JP)

(72) Inventors: Tomohiro SEKIGUCHI, Osaka (JP); Kiyotaka NAKASE, Osaka (JP); Takayuki FURUKAWA, Osaka (JP)

(21) Appl. No.: 14/601,703

(22) Filed: Jan. 21, 2015

Related U.S. Application Data
(63) Continuation of application No. PCT/JP2014/001689, filed on Mar. 25, 2014.

(30) Foreign Application Priority Data
Jul. 31, 2013 (JP) 2013-158601

(51) Int. Cl. G02F 1/1333; G02F 1/1335

(52) U.S. Cl. CPC G02F 1/133385; G02F 1/133603; G02F 1/133608
USPC 349/69

(57) ABSTRACT

A display device includes: a display panel; a plurality of backlight units disposed on a rear side of the display panel; a first frame disposed on a rear side of the backlight units; a heat transfer sheet disposed on a rear side of the first frame above a predetermined position; and a second frame disposed on a rear side of the heat transfer sheet. An air layer is formed between the first frame and the second frame, below the heat transfer sheet.

### BACKGROUND OF THE INVENTION

1. Field of the Invention

The present disclosure relates to a display device, and more particularly to a liquid crystal display device provided with an LED (Light Emitting Diode) direct backlight.

2. Description of the Related Art

In recent years, a liquid crystal display device provided with a high-luminance LED direct backlight has been put on the market. This type of a liquid crystal display device includes LEDs arranged throughout a liquid crystal screen at positions immediately below the screen, and supplies power to these LEDs arranged throughout the screen.

For the purpose of raising luminance, the liquid crystal display device needs to supply a larger amount of power to the LEDs. When the power supply to the LEDs increases, the temperature of the LEDs rises. With a rise of the temperature of the LEDs, air heated to a high temperature shifts from a lower area to an upper area due to natural convention. This condition forms a large temperature gradient between a lower portion and an upper portion of the backlight. The temperature gradient thus formed causes luminance nonuniformity and color nonuniformity.

In addition, a driver board of the high-luminance LED direct backlight provided for driving the LEDs consumes a large amount of power. Accordingly, the quantity of heat released from the driver board increases; therefore, the temperature of the driver board rises. As a result, the local temperature of the backlight in an area around the driver board rises, so that a temperature gradient is formed in the backlight.

As a technology for avoiding formation of a temperature gradient within a liquid crystal panel, Patent Literature 1 discloses a constitution in which heated air is discharged from air holes of a duct structure constituted by an auxiliary plate.

### CITATION LIST

### Patent Literature

PTL 1: Unexamined Japanese Patent Publication No. 2005-121897

### SUMMARY OF THE INVENTION

It is an object of the present disclosure to provide a display device which includes a structure capable of reducing a temperature gradient.

A display device according to the present disclosure includes: a display panel; a plurality of backlight units disposed on a rear side of the display panel; a first frame disposed on a rear side of the plurality of the backlight units; a heat transfer sheet disposed on a rear side of the first frame above a predetermined position; and a second frame disposed on a rear side of the heat transfer sheet. An air layer is formed between the first frame and the second frame, below the heat transfer sheet.

This structure decreases a temperature peak and a temperature gradient of a heat generating component.

### BRIEF DESCRIPTION OF DRAWINGS

FIG. 1 is a perspective view illustrating a disassembled structure of a liquid crystal display device according to a first exemplary embodiment.

FIG. 2A is a rear view of the liquid crystal display device according to the first exemplary embodiment.

FIG. 2B is a cross-sectional view of the liquid crystal display device taken along a line 2-2 in FIG. 2A.

FIG. 2C is a view illustrating heat flow in the cross-sectional in FIG. 2B.

FIG. 3A is a rear view of a conventional liquid crystal display device.

FIG. 3B is a cross-sectional view of the liquid crystal display device taken along a line 3-3 in FIG. 3A.

FIG. 3C is a view illustrating heat flow in the cross-sectional in FIG. 3B.

FIG. 4A is a characteristic diagram showing a temperature gradient of a first frame included in the conventional liquid crystal display device.

FIG. 4B is a characteristic diagram showing a temperature gradient of a first frame included in the liquid crystal display device according to the first exemplary embodiment.

FIG. 5A is a rear view of a liquid crystal display device according to a second exemplary embodiment.

FIG. 5B is a cross-sectional view of the liquid crystal display device taken along a line 5-5 in FIG. 5A.

FIG. 6A is a rear view of a liquid crystal display device according to a third exemplary embodiment.

FIG. 6B is a cross-sectional view of the liquid crystal display device taken along a line 6-6 in FIG. 6A.

FIG. 7A is a rear view of another liquid crystal display device according to the third exemplary embodiment.

FIG. 7B is a cross-sectional view of the liquid crystal display device taken along a line 7-7 in FIG. 7A.

### DETAILED DESCRIPTION OF THE PREFERRED EMBODIMENTS

Exemplary embodiments are hereinafter described in detail with reference to the drawings. In the following description, excessively detailed explanation may be omitted. For example, detailed description of well-known matters, or repeated description of substantially identical configurations may be omitted. These omissions are made for avoiding unnecessary redundancy of explanation in the following description, and helping those skilled in the art easily understand the contents of the description.

The accompanying drawings and the following description are presented only for the purpose of helping those skilled in the art fully to understand the present disclosure. It is therefore not intended that the scope of the subject matters as claimed in the claims be limited in any way to the accompanying drawings and the following description.

### First Exemplary Embodiment

A first exemplary embodiment is hereinafter described.

### [1-1. Constitution]

Positions and directions in the following description, such as “front” and “rear” sides, are defined on the basis of a display direction of a liquid crystal display device unless particularly noted otherwise. More specifically, in a liquid crystal display device, a side of a liquid crystal display panel where an image is displayed corresponds to a “front” side, while the opposite side of the liquid crystal display panel corresponds to a “rear side”. In addition, directions of “up” and “down” in the following description correspond to directions of “up” and “down” when the liquid crystal display panel is viewed from the front side in a posture of use of the liquid crystal display device.

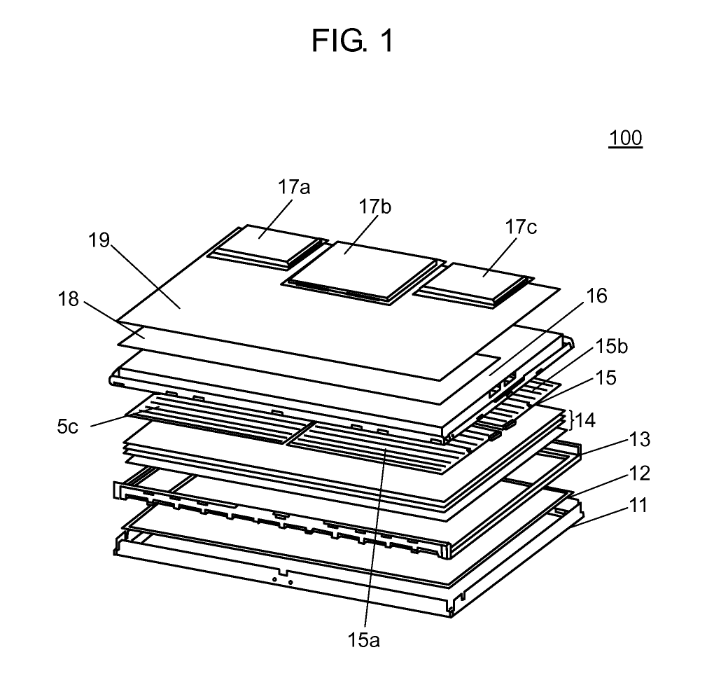

FIG. 1 is a perspective view illustrating a disassembled structure of the liquid crystal display device according to the first exemplary embodiment.

As illustrated in FIG. 1, liquid crystal display device 100 is provided with an LED direct backlight. Liquid crystal display device 100 includes front frame 11, liquid crystal display panel 12 constituted by a 33-inch flat display panel, mold frame 13, optical sheet 14 constituted by a diffusion sheet or a prism sheet, for example, backlight device 15, first frame 16, circuit board 17b containing a plurality of electronic components such as a drive circuit and a memory for displaying images on liquid crystal display panel 12, driver boards 17a and 17c for driving backlight device 15, heat transfer sheet 18, and second frame 19.

Front frame 11 is made of resin, metal, or other materials, and disposed on the front side of liquid crystal display device 100. Front frame 11 surrounds a circumference of liquid crystal display panel 12, and fixes and holds liquid crystal display panel 12.

Mold frame 13 is made of resin, metal, or other materials, and disposed on the rear side of liquid crystal display panel 12. Mold frame 13 fixes and holds liquid crystal display panel 12 and optical sheet 14.

First frame 16 is disposed on the rear side of backlight device 15.

Heat transfer sheet 18 is disposed in an upper portion of the rear side of first frame 16, and positioned as to face a predetermined position of first frame 16, i.e., an area in a range from substantially the center to the upper portion of first frame 16 as viewed in FIG. 1.

Second frame 19 is disposed on the rear side of heat transfer sheet 18, and positioned as to face first frame 16 in a range from a lower portion to the upper portion of first frame 16.

Circuit board 17b and driver boards 17a and 17c are disposed substantially in a lower portion of the rear side of second frame 19.

Liquid crystal display panel 12 includes horizontal and vertical polarizing filters, a glass substrate, and a liquid crystal orientation layer, and is disposed on the front side of backlight device 15. Liquid crystal display panel 12 has an image display area where images are displayed. This liquid crystal display area is disposed on the front side of liquid crystal display panel 12, and exposed to the outside through an opening of front frame 11.

Backlight device 15 is constituted by four backlight units 15a through 15d, and contains LED light sources arranged throughout the area of backlight device 15 both in the length and width directions.

First frame 16 is made of a metal material having high thermal conductivity and high electric conductivity, such as iron and aluminum.

Liquid crystal display panel 12 is held by junction between front frame 11 and mold frame 13 via a junction member. Optical sheet 14 and backlight device 15 are held on first frame 16 by junction between front frame 16 and both backlight device 15 and mold frame 13 via a junction member.

First frame 16 provides functions of both a chassis for holding optical sheet 14 and backlight device 15, and a heat sink constituted by a metal body for radiating heat generated from backlight device 15.

Grooves are formed in an outer circumference of first frame 16. These grooves are portions where wiring and the like are embedded.

A plurality of electronic components such as a driving circuit, a signal processing circuit, and a memory for driving liquid crystal display panel 12 are provided on the rear side of circuit board 17b. On the other hand, a plurality of electronic components such as a driving circuit, a signal processing circuit, and a memory for driving backlight device 15 are provided on the rear side of driver boards 17a and 17c for each.

Heat transfer sheet 18 is made of a heat radiation rubber, for example.

Second frame 19 is made of metal material having high thermal conductivity and high electric conductivity, such as aluminum and copper.

The surfaces of first frame 16 and second frame 19 in the areas facing each other have the same size except for the area of first frame 16 where the grooves are formed.

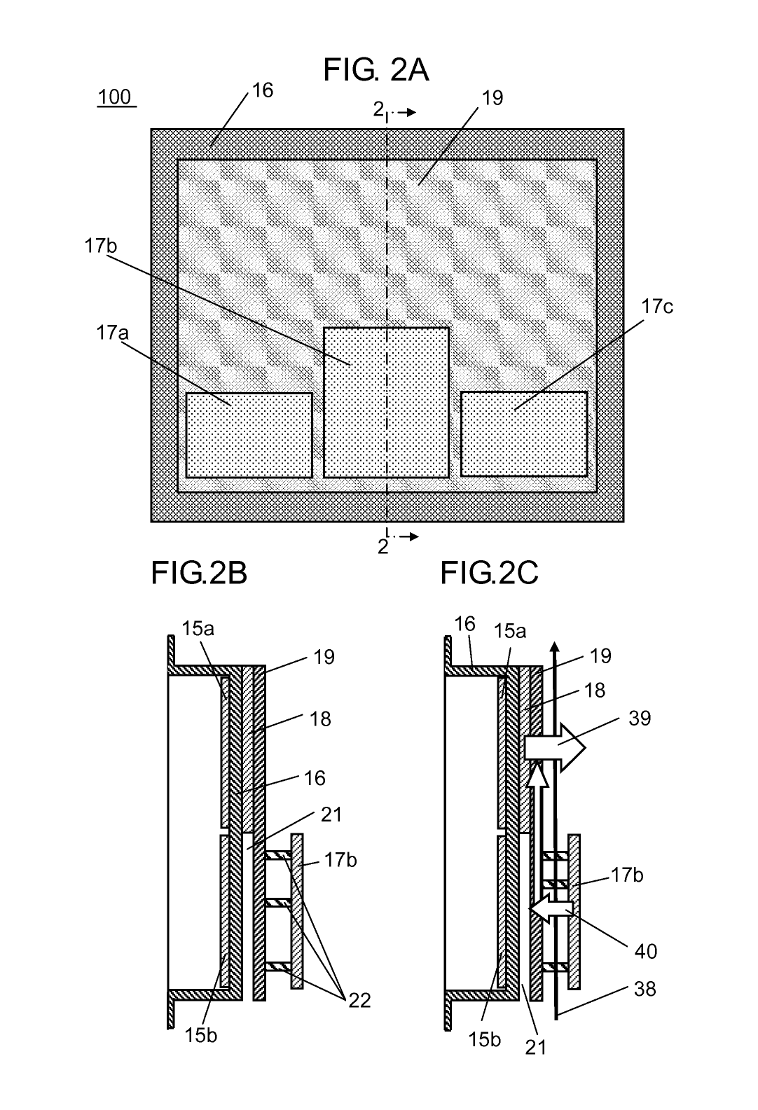

FIG. 2A is a rear view of liquid crystal display device 100. FIG. 2B is a cross-sectional view of liquid crystal display device 100 taken along a line 2-2 in FIG. 2A. This cross-sectional view shows a cross section of liquid crystal display device 100 in a range from the rear side of circuit board 17b to backlight device 15, and does not show a constitution in a range from optical sheet 14 to front frame 11. FIG. 2C illustrates heat flow in the cross section in FIG. 2B.

As illustrated in FIG. 2B, circuit board 17b is held on the rear side of second frame 19 with a constant distance left between circuit board 17b and second frame 19 by the use of a plurality of bosses 22 made of a metal material. Though not shown in the figure, driver boards 17a and 17c are held on the rear side of second frame 19 similarly to circuit board 17b with the same distance as that of circuit board 17b left between driver boards 17a and 17c and second frame 19 by the use of a plurality of bosses.

Heat transfer sheet 18 is disposed between first frame 16 and second frame 19 at a predetermined position, i.e., throughout an area from substantially the center to an upper portion between first frame 16 and second frame 19 according to this exemplary embodiment. A thickness of heat transfer sheet 18, i.e., a distance between first frame 16 and second frame 19 is 0.25 mm. According to this structure, air layer 21 having the same thickness as that of heat transfer sheet 18 is formed throughout an area between first frame 16 and second frame 19, below heat transfer sheet 18. Air layer 21 has a rectangular area having a length from the lowermost end of the plane of first frame 16 to the lowermost end of heat transfer sheet 18 in the vertical direction, and a width from the left end of first frame 16 to the right end of first frame 16 in the horizontal direction, when first frame 16 is viewed from the rear side.

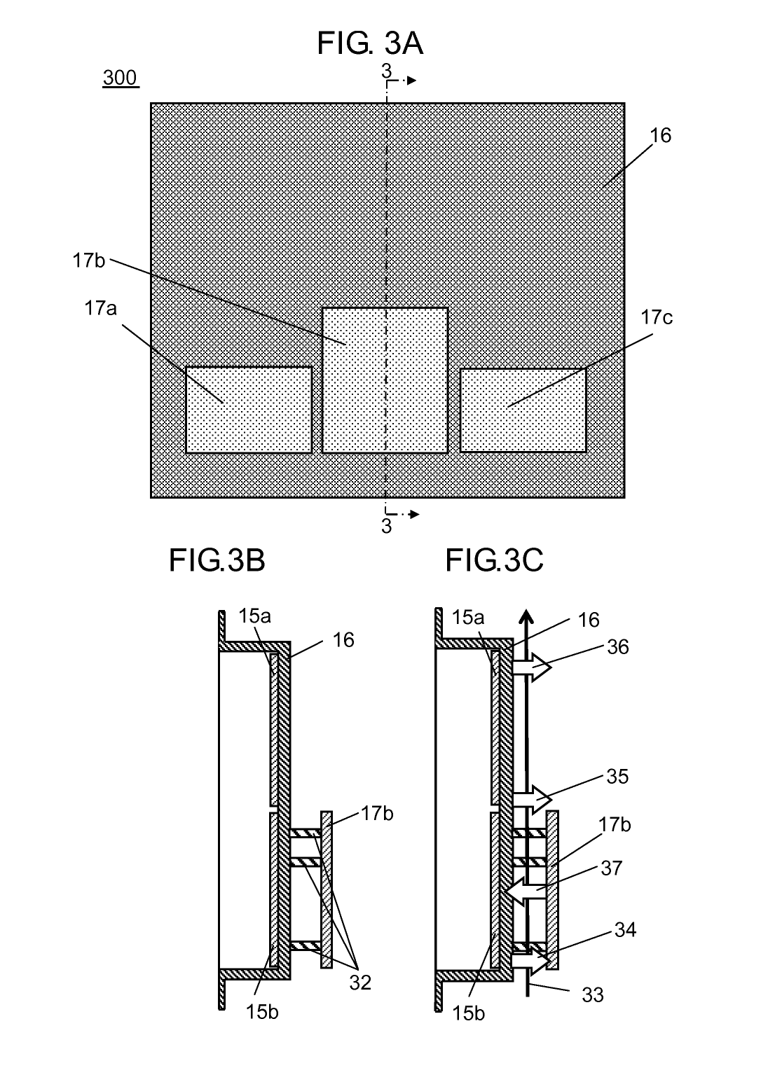

FIG. 3A is a rear view of conventional liquid crystal display device 300. FIG. 3B is a cross-sectional view of liquid crystal display device 300 taken along a line 3-3 in FIG. 3A. Liquid crystal display device 300 does not contain the constitution of heat transfer sheet 18 and second frame 19 in comparison with the structure of liquid crystal display device 100. FIG. 3B does not show the constitution in the range from optical sheet 14 to front frame 11 similarly to FIG. 2B. FIG. 3C illustrates heat flow in the cross section in FIG. 3B.

As illustrated in FIG. 3B, circuit board 17b is held on the rear side of first frame 16 with a constant distance left between circuit board 17b and first frame 16 by the use of a plurality of bosses 32 made of metal material. Though not shown in the figure, driver boards 17a and 17c are held on the rear side of first frame 16 similarly to circuit board 17b with the same distance as that of circuit board 17b left between driver boards 17a and 17c and first frame 16 by the use of a plurality of bosses.

### [1-2. Operation]

Firstly described is a case when conventional liquid crystal display device 300 operates. During operation of liquid crystal display device 300, backlight device 15 does not convert all the supplied power into light, but releases a part of the power as heat. As a result, the entire temperature of liquid crystal display device 300 rises. In addition, the electronic components disposed on circuit board 17b and driver boards 17a and 17c similarly release a part of the supplied power as heat.

First frame 16 is made of a metal material; therefore, heat generated from backlight device 15 is conducted to first frame 16 and raises the temperature of first frame 16. Moreover, the temperature of air on the rear side of first frame 16 rises with the rise of the temperature of first frame 16. With the rise of the temperature of the air, the density of the air decreases, so that upward current 33 is generated. Upward current 33 causes release of the heat of first frame 16 to the entire area on the rear side of first frame 16. The heat flow thus generated is schematically indicated by heat flow 34, 35, and 36. Upward current 33 receives a larger quantity of heat as upward current 33 rises from a lower portion to an upper portion; therefore the temperature difference between upward current 33 and first frame 16 decreases as upward current 33 rises. In this case, the air in the upper portion of first frame 16 provides a smaller cooling effect for first frame 16 than the air in the lower portion of first frame 16. Accordingly, a temperature gradient is formed between the upper portion and the lower portion of first frame 16.

Furthermore, the heat generated from the electronic components disposed on circuit board 17b and driver boards 17a and 17c is conducted to first frame 16 as indicated by heat flow 37, and raises the temperature of first frame 16. In this case, the temperature of first frame 16 locally rises at the positions where the electronic components of circuit board 17b and driver boards 17a and 17b are disposed as viewed from the rear side of first frame 16.

Described next is the case when liquid crystal display device 100 operates. During operation of liquid crystal display device 100, backlight device 15 does not convert all the supplied power into light, but releases a part of the power as heat. As a result, the entire temperature of liquid crystal display device 100 rises. In addition, the electronic components disposed on circuit board 17b and driver boards 17a and 17c similarly release a part of the supplied power as heat.

First frame 16 is made of metal material; therefore, heat generated from backlight device 15 is conducted to first frame 16 and raises the temperature of first frame 16. Moreover, the temperature of air on the rear side of first frame 16 rises with the rise of the temperature of first frame 16. With the rise of the temperature of the air, the density of the air decreases, so that upward current 38 is generated. Upward current 38 causes release of the heat of first frame 16 to the entire area on the rear side of first frame 16.

The heat in the upper portion of first frame 16 is conducted to heat transfer sheet 18 and second frame 19 in this order, and allowed to be released with upward current 38 generated on the rear side of second frame 19 as indicated by heat flow 39.

Air layer 21 has a thickness of 0.25 mm; therefore, air in air layer 21 does not flow even when the temperature of first frame 16 rises. In this case, convective heat transfer does not occur in air layer 21, and heat conductivity of air is sufficiently low; therefore, these conditions provide insulation effectiveness for air layer 21. Accordingly, air layer 21 having this insulation effectiveness insulates heat generated from the lower portion of first frame 16, and prevents release of the heat with upward current 38 generated on the rear side of second frame 19.

In addition, upward current 38 receives a limited quantity of heat from the lower portion of first frame 16, so that the temperature rise of the air during upward rising decreases in comparison with the corresponding temperature rise in the case of conventional liquid crystal display device 300. As a result, the quantity of heat release becomes larger in the upper portion of first frame 16.

In this case, the temperature rise of the lower portion of first frame 16 increases, while the temperature rise of the upper portion of first frame 16 decreases. Accordingly, the temperature gradient in the plane of first frame 16 of liquid crystal display device 100 becomes smaller.

On the other hand, the heat generated from the electronic components of circuit board 17b and driver boards 17a and 17c is conducted to second frame 19 via heat flow 40 generated by conductive heat transfer. However, this heat is difficult to be conducted to first frame 16 by the function of air layer 21 having insulation effectiveness, and therefore diffuses in the plane of second frame 19. As a result, the local temperature rise of first frame 16 produced by the heat of the electronic components on circuit board 17b and driver boards 17a and 17c decreases, so that the temperature gradient of first frame 16 becomes smaller.

A simulation was carried out by using Heat Designer PAC V8 manufactured by Software Cradle Co., Ltd. for comparison between the temperature gradient of first frame 16 of conventional liquid crystal display device 300 and the temperature gradient of first frame 16 of liquid crystal display device 100 according to this exemplary embodiment. The simulation was carried out under the following conditions. Assumed in the simulation was a 33-inch liquid crystal panel. The quantity of heat released from backlight device 15 was set to 120 W. The quantity of heat released from circuit board 17b was set to 5 W. The quantity of heat released from driver boards 17a and 17b for each was set to 25 W. The heat conductivity of the heat transfer sheet was set to 1 w/(° C.·m).

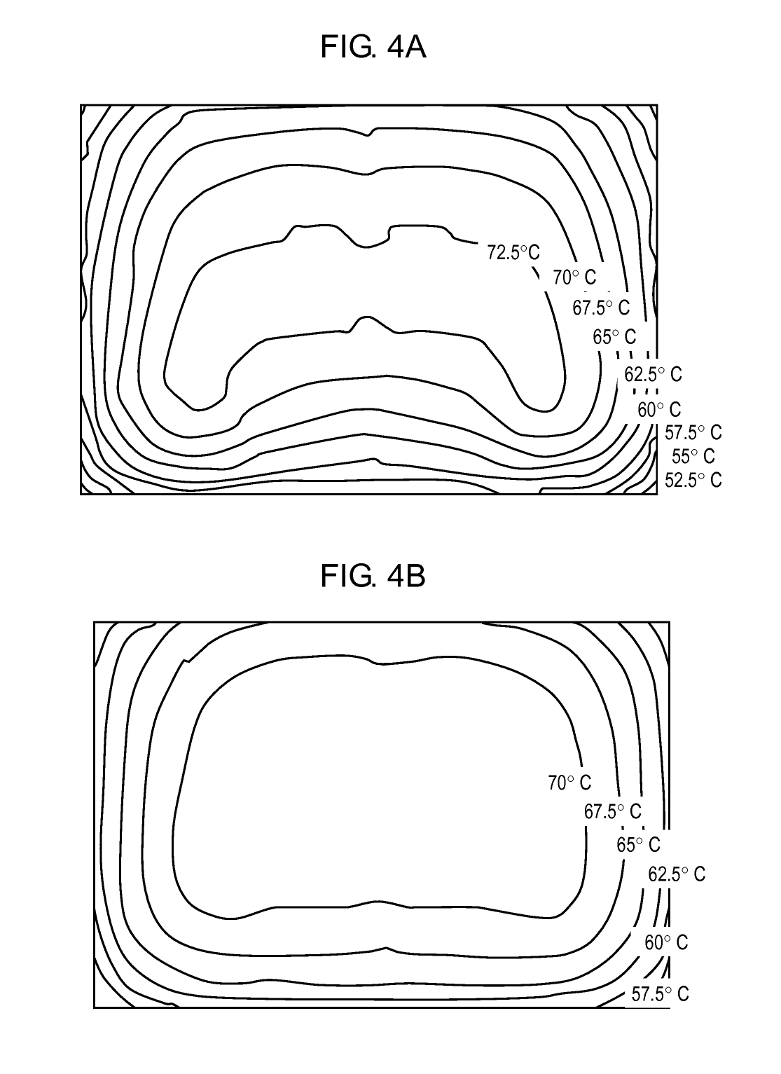

FIG. 4A is a characteristic diagram showing a temperature gradient obtained from the result of the foregoing simulation using first frame 16 of conventional liquid crystal display device 300. FIG. 4B is a characteristic diagram showing a temperature gradient obtained from the result of the foregoing simulation using first frame 16 of liquid crystal display device 100 according to this exemplary embodiment.

As illustrated in FIG. 4A, the temperature of the central portion of first frame 16 was 72.5° C., while the lower portion of first frame 16 was 52.5° C. Accordingly, a temperature difference of 20° C. was produced. Particularly, the local temperature of the central portion was higher than the temperature of the other area.

On the other hand, as illustrated in FIG. 4B, the temperature of the central portion of first frame 16 was 70° C., while the temperature of the lower portion of first frame 16 was 57.5° C. Accordingly, a temperature difference of 12.5° C. was produced. In addition, the temperature of the central portion of first frame 16 was 2.5° C. lower than the temperature of the corresponding portion of conventional liquid crystal display device 300.

Accordingly, liquid crystal display device 100 in this exemplary embodiment efficiently conducts the heat generated from the upper portion of first frame 16 to heat transfer sheet 18 and second frame 19 and releases the heat, while reducing release of the heat generated from the lower portion of first frame 16 by the function of air layer 21. This structure decreases the temperature peak and the temperature gradient of first frame 16, thereby reducing luminance nonuniformity and color nonuniformity.

Moreover, the heat generated from circuit board 17b and driver boards 17a and 17b provided on second frame 19 is insulated by the function of air layer 21. This structure lowers thermal effect of the heat. In addition, the heat generated from the circuit board 17b and driver boards 17a and 17b is released through the plane of second frame 19. This structure allows easy heat designing.

Next, a simulation was carried out for determining variations of the temperature gradient of liquid crystal display device 100 according to this exemplary embodiment produced by changes of the thickness of heat transfer sheet 18.

The simulation was carried out by using Heat Designer PAC V8 manufactured by Software Cradle Co., Ltd. under the following conditions. Assumed in the simulation was a 33-inch liquid crystal panel. The quantity of heat released from backlight device 15 was set to 120 W. The quantity of heat released from circuit board 17b was set to 5 W. The quantity of heat released from driver boards 17a and 17b for each was set to 25 W. The heat conductivity of the heat transfer sheet was set to 1 w/(° C.·m). Table 1 shows simulation results obtained when the thickness of heat transfer sheet 18 was changed in a range from 0 mm to 5 mm.

TABLE 1

| THICKNESS | | | |
|---|---|---|---|
| OF HEAT | | TEMPERATURE | |
| TRANSFER | TEMPERATURE | GRADIENT | MAXIMUM |
| SHEET | GRADIENT | DIFFERNCE | TEMPERATURE |
| (mm) | (° C.) | (° C.) | (° C.) |
| 0 | 17 | — | 73.4 |
| 0.01 | 13.4 | 3.6 | 71.8 |
| 0.05 | 12.1 | 4.9 | 71.3 |
| 0.10 | 11.1 | 5.9 | 71.2 |
| 0.25 | 11.1 | 5.9 | 71.4 |
| 0.5 | 11.5 | 5.5 | 71.9 |
| 1.00 | 12.1 | 4.9 | 72.5 |
| 2.00 | 14.6 | 2.4 | 72.8 |
| 5.00 | 16.1 | 0.9 | 72.9 |

The table shows a temperature gradient, a temperature gradient difference, and a maximum temperature of each sheet based on the simulation carried out for measuring the maximum and minimum temperatures for each thickness of heat transfer sheet 18. The temperature gradient difference in this context refers to a difference from a temperature gradient of 17° C. of the structure including a O-mm-thick air layer, i.e., the structure of conventional liquid crystal display device 300. The results of the simulation show that the temperature gradient difference was 3.6° C. or more from the temperature gradient of conventional liquid crystal display device 300, and that the maximum temperature was maintained at 72.5° C. or lower, i.e., a temperature lower than the maximum temperature of conventional liquid crystal display device 300 by 0.9° C. or more, when the thickness of heat transfer sheet 18 is in a range from 0.01 mm to 1.00 mm.

Particularly, it was found that the temperature gradient difference was 5° C. or more from the temperature gradient of conventional liquid crystal display device 300 when the thickness of heat transfer sheet 18 is in a range from 0.1 mm to 0.5 mm. In addition, the maximum temperature was maintained at approximately 72° C., which is lower by approximately 1.4° C. than the corresponding temperature of conventional liquid crystal display device 300.

### [1-3. Advantages and Others]

Accordingly, a display device according to this exemplary embodiment includes: a display panel; a plurality of backlight units disposed on the rear side of the display panel; a first frame disposed on the rear side of the plurality of the backlight units; a heat transfer sheet disposed on the rear side of the first frame above a predetermined position; and a second frame disposed on the rear side of the heat transfer sheet. An air layer is formed between the first frame and the second frame, below the heat transfer sheet.

This structure decreases a maximum temperature while decreasing a temperature gradient, thereby reducing luminance nonuniformity and color nonuniformity.

### Second Exemplary Embodiment

A second exemplary embodiment is hereinafter described.

### [2-1. Constitution]

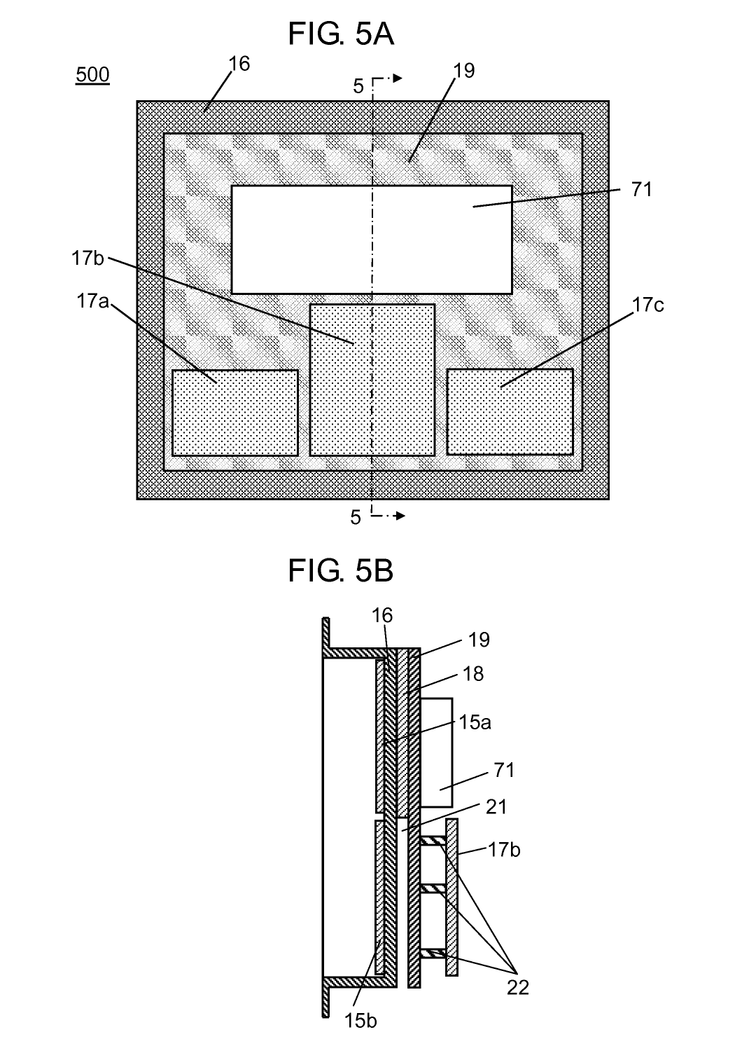

FIG. 5A is a rear view of liquid crystal display device 500 according to the second exemplary embodiment. FIG. 5B is a cross-sectional view taken along a line 5-5 in FIG. 5A. FIG. 5B does not show the constitution from optical sheet 14 to front frame 11 similarly to FIG. 2B. Liquid crystal display device 500 is different from liquid crystal display device 100 according to the first exemplary embodiment in that liquid crystal display device 500 has heat release member 71, such as a heat sink, made of a metal material having high thermal conductivity and high electric conductivity, such as aluminum and copper. Heat release member 71 is disposed on the rear side of second frame 19, and positioned in the area of the upper portion of first frame 16 where the temperature of first frame 16 rises to the maximum.

### [2-2. Operation]

When heat release member 71 is provided in the area of the upper portion of first frame 16 where the temperature rises to the maximum, both the heat release quantity of heat from the upper portion of first frame 16, and the heat release quantity of heat generated from the electronic components on circuit board 17b and driver boards 17a and 17c, conducted to second frame 19 by convective heat transfer, and dispersed in the upper portion of second frame 19 within the plane of second frame 19 increase in comparison with the corresponding heat release quantities of a structure not including heat release member 71.

### [2-3. Advantages and Others]

For the purpose of raising the necessary luminance of liquid crystal display device 500, the power supplied to driver boards 17a and 17c needs to increase. In this case, the quantities of heat released from backlight device 15 and driver boards 17a and 17c become larger. In this case, the temperature difference between the upper portion and the lower portion of first frame 16 is enlarged. According to this exemplary embodiment, however, heat release member 71 reduces the temperature rise of the upper portion, thereby providing excellent temperature gradient reduction effect.

### Third Exemplary Embodiment

A third exemplary embodiment is hereinafter described.

### [3-1. Constitution]

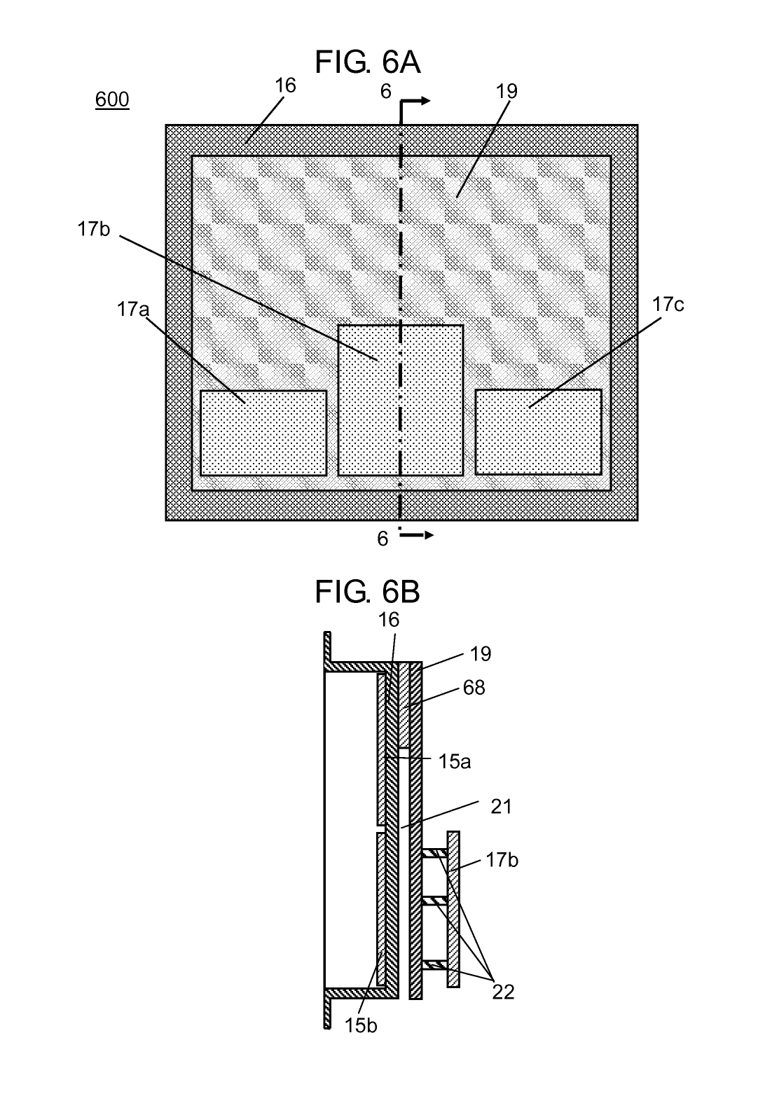

FIG. 6A is a rear view of liquid crystal display device 600 according to the third exemplary embodiment. FIG. 6B is a cross-sectional view taken along a line 6-6 in FIG. 6A. FIG. 6B does not show the constitution from optical sheet 14 to front frame 11 similarly to FIG. 2B.

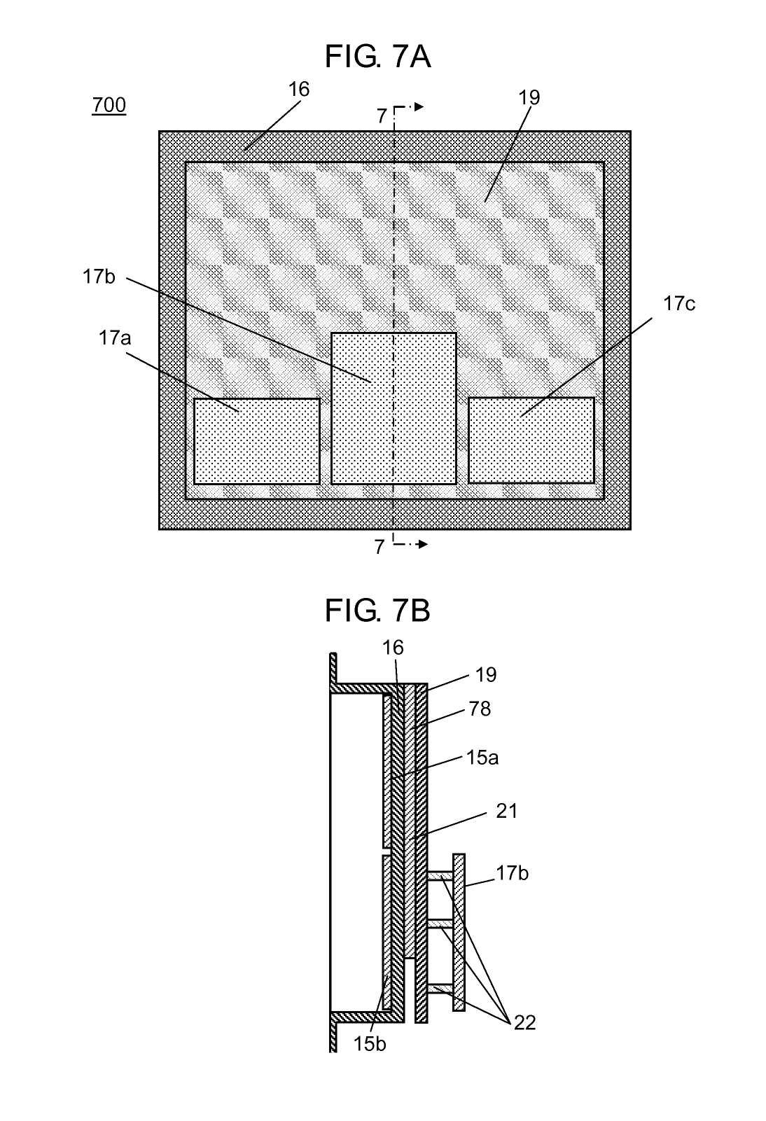

FIG. 7A is a rear view of liquid crystal display device 700 according another example of the third exemplary embodiment. FIG. 7B is a cross-sectional view taken along a line 7-7 in FIG. 7A.

Liquid crystal display device 600 is different from liquid crystal display device 100 according to the first exemplary embodiment in the area covered by heat transfer sheet 68. Heat transfer sheet 68 is smaller than heat transfer sheet 18 in the up-down direction. Heat transfer sheet 68 has approximately one fourth of the area of the rear surface of first frame 16. Liquid crystal display device 700 is different from liquid crystal display device 100 according to the first exemplary embodiment in the area covered by heat transfer sheet 78. Heat transfer sheet 78 is larger than heat transfer sheet 18 in the up-down direction. Heat transfer sheet 78 has approximately three fourths of the area of the rear surface of first frame 16.

### [3-2. Operation]

When the area of heat transfer sheet 68 contracts upward as illustrated in FIG. 6B, the area of air layer 21 increases. This structure upwardly expands the area of air layer 21, thereby upwardly increasing the area for insulating heat generated from first frame 16 by the function of air layer 21 having insulation effectiveness in comparison with the first exemplary embodiment.

When the area of heat transfer sheet 78 expands downward as illustrated in FIG. 7B, the area of air layer 21 decreases. According to this structure, the area for insulating heat generated from first frame 16 by air layer 21 is limited only to a lower area in comparison with the first exemplary embodiment.

### [3-3. Advantages and Others]

In comparison with the first exemplary embodiment, the area of heat transfer sheet 68 or the area of heat transfer sheet 78 according to this exemplary embodiment is contracted or expanded in the up-down direction in accordance with shift of the area of first frame 16 where the temperature within the plane of first frame 16 becomes the maximum in the upward direction in FIG. 6B or downward direction in FIG. 7B. This structure allows adjustment of the heat release quantities from the upper portion and the lower portion of first frame 16. Accordingly, the temperature gradient decreases even when the distribution of the temperature gradient of first frame 16 varies.

According to the first through third exemplary embodiments, backlight device 15 is constituted by LED light sources. However, the backlight may be other types of light sources such as organic light-emitting diodes (OLEDs) and a fluorescent tube. In addition, backlight device 15 is not limited to a direct type as in the exemplary embodiments, but may be an edge light type or other types.

What is claimed is:

1. A display device comprising:
a display panel;
a plurality of backlight units disposed on a rear side of the display panel;
a first frame disposed on a rear side of the plurality of the backlight units;
a heat transfer sheet disposed on a rear side of the first frame above a predetermined position; and
a second frame disposed on a rear side of the heat transfer sheet, wherein
an air layer is formed between the first frame and the second frame, below the heat transfer sheet.

2. The display device according to claim 1 further comprising:
a board disposed on a rear side of the second frame and including an electronic component,
wherein the board is disposed below the predetermined position.

3. The display device according to claim 1, wherein the predetermined position is located at a center of a length of the first frame extending in an up-down direction of the first frame.

4. The display device according to claim 1, wherein a thickness of the heat transfer sheet ranges from 0.01 mm to 1.00 mm both inclusive.

5. The display device according to claim 1, wherein a thickness of the heat transfer sheet ranges from 0.1 mm to 0.5 mm both inclusive.
